(19) United States
(12) Patent Application Publication
(10) Pub. No.: US 2018/0106418 A1
(43) Pub. Date: Apr. 19, 2018

(54) IMAGING STAND

(71) Applicant: Troy Anglin, Miami Gardens, FL (US)

(72) Inventor: Troy Anglin, Miami Gardens, FL (US)

(21) Appl. No.: 15/724,348

(22) Filed: Oct. 4, 2017

Related U.S. Application Data
(60) Provisional application No. 62/407,934, filed on Oct. 13, 2016.

(51) Int. Cl. F16M 11/28

(52) U.S. Cl. CPC F16M 11/28; F16M 11/041

(57) ABSTRACT

Example embodiments for a stand for mounting a portable electronic device having an optical sensor are provided. The stand permits hands free operation of the portable electronic device for capturing the image or video using the optical sensor. Further, the stand allows tracking the capture the image or video of a moving user. Furthermore, the stand can be adapted like a selfie stick. Furthermore, the stand comprises a telescopic shaft vertically supported on a base unit and coupled to a head unit at top. The base unit includes a tripod or a quad stand that is foldable. The head unit comprises a housing enclosing a motor and control unit that rotates the holder at a desired angle. The holder is used for mounting the electronic devices.

### CROSS REFERENCE TO RELATED APPLICATION

This application claims priority to U.S. Provisional Patent Application No. 62/407,934 filed on 13 Oct. 2016, which is incorporated herein in its entirety by reference.

### FIELD

The present disclosure relates to a stand for portable electronic devices equipped with a camera and in particular, the present disclosure relates to the stand for portable electronic devices equipped with a camera for remote operation of camera.

### BACKGROUND

Cameras are one of the widely used electronic devices and different types of cameras has been produced for multiple applications, for example recording videos, capturing images, video conferencing etc. Furthermore, the communication devices such as smart phones are equipped with cameras and provide a quick and easy way to capture both images and video. To use the camera, a user simply holds the device in hand and points the optical lens of the camera on the subject being captured.

Stands for cameras generally known as tripods are available and used to mount the camera for hands-free operation. Typically, the tripods and similar stands for cameras are used to stabilize the camera and prevent any blur caused by shaking of the hands, providing clear and sharp images of the subjects captured. The camera mounted on the stand may be manually operated by pressing the shutter by the user or remotely using a remote-control device. The remote operation of the shutter has an advantage of further reducing any vibrations to the camera by manually pressing the shutter using hands.

Prior art discloses myriad of designs of tripod and similar stands for cameras and smart phones, however the user has to manually adjust the angle of camera each time, and if the subject to be captured is moving, the camera has to be continuously focused towards the subject. Furthermore, if the user is engaged in a video conference or is casually shooting themselves, they have to remain within the field of view of the stationary camera.

Thus, there is a need for a stand that may allow a camera or a smart phone to be remotely or automatically panned at desired angle.

### BRIEF SUMMARY

The present disclosure, therefore, provides a stand for a portable electronic device equipped with an optical sensor.

In an example embodiment, the stand is configured to mount different types of cameras.

In another example embodiment, the stand is configured to mount the smart phones having inbuilt cameras.

In another example embodiment, the stand may be remotely operated to pan the mounted camera at desired angle.

Still in another example embodiment, the stand may track the movement of subject and continuously adjust the camera according to the movements of the subject.

Still in another example embodiment, the stand may be adapted as a selfie stick.

In yet another example embodiment, the stand is economical to manufacture and compact for carrying.

Certain embodiments of present disclosure, but are not limited to, provides a stand that may be used to mount portable electronic devices having camera, such as digital cameras and smartphones, for hands-free operation of the camera. In one embodiment, the stand according to present disclosure, comprises a telescopic shall vertically supported on a base unit and coupled to a head unit at the top. In another embodiment, the base unit includes a block having three to four legs pivotally secured to the block, a stem projecting downwards from the block and three to four leg braces extending from the end of the stem and coupled to the three or four legs, permitting folding and unfolding of the legs. In another embodiment, the head unit comprises a base plate and a rotating plate that is rotatably mounted on the base plate. A motor is provided for rotating the rotating plate. A control unit is operably coupled to the motor for facilitating the operation of the motor, thus controlling the rotation of the rotating plate. A holder is mounted on the rotating plate and the holder is adapted to clamp the portable electronic device equipped with the camera. In another embodiment, the holder is adapted to clamp different kinds of cameras and smart phones. Moreover, the holder permits manually setting the camera or smart phone at a desired tilt angle.

In another embodiment, the head unit is provided with one or more sensor operably coupled to the control unit and configured to track the location of the transmitter. The transmitter is adapted to be worn by the subject such that the sensor mounted on the head unit may track the transmitter and permit the control unit to pan the camera according to the real-time location of the subject. In another embodiment, the control unit is configured to be remotely controlled for turning the rotating plate to pan the camera at desired angle. In another embodiment, the head unit is configured to remotely operate the camera or the smartphone clamped to the holder. In another example embodiment, the block of base unit includes a button operably coupled to the control unit for operating the shutter of the camera/smart phone.

In another example embodiment, a portable stand for mounting a portable electronic device, comprises a telescopic shaft vertically supported on a base, the telescopic shaft being coupled to a housing at a top end, the base including a block coupled to the shaft and at least three lees pivotally coupled to the block wherein each leg is further supported by a leg brace permitting the base to unfold and fold; a motor enclosed in the housing and operably coupled to a holder through a coupling means, the holder being configured to clamp the portable electronic device, the motor being configured to rotate the holder; a controller enclosed in the housing and operably coupled to the motor to control the operation of the motor; at least one sensor operably coupled to the controller and configured to receive signal from a transmitter, the at least one sensor being configured to send a location signal to the controller to rotate the portable electronic device; a remote device configured to be worn by a user, the remote device including the transmitter; wherein the controller is configured to receive the location signal from the at least one sensor in real time and continuously focus the sensor on the user.

### BRIEF DESCRIPTION OF THE DRAWINGS

To further clarify various aspects of some example embodiments of the present disclosure, a more particular description of the disclosure will be rendered by reference to specific embodiments thereof which are illustrated in the appended drawing. It is appreciated that the drawing depicts only illustrated embodiments of the disclosure and are therefore not to be considered limiting of its scope. The disclosure will be described and explained with additional specificity and detail through the use of the accompanying drawing.

The example embodiments of the inventive aspects will be better understood from the following brief description taken in conjunction with the accompanying drawings. The drawing FIGS. 1-12, represent non-limiting, example embodiments.

FIG. 1 illustrates a stand with the holder being a mounted smart phone, according to an example embodiment.

FIG. 2 illustrates an extended telescopic shaft coupled to the base unit including a push button, according to an example embodiment.

FIG. 3 illustrates a wearable remote device used to operate the stand, according to an example embodiment.

FIG. 4 illustrates a smart phone tilted at 90 degrees, according to an example embodiment.

FIG. 5 illustrates the interconnection of the controller and motor configured to control the position and orientation of the electronic device, according to an example embodiment.

FIG. 6 illustrates interconnection with the camera and motor, according to an example embodiment.

FIG. 7 illustrates steps involved in motor control based on the position of the target, according to an example embodiment.

FIG. 8 illustrates interconnection at the remote device side, according to an example embodiment.

FIG, 9 shows a product overview with an extended telescopic shaft, according to an example embodiment.

FIG. 10 shows a product overview with the extended telescopic shaft and expanded legs, according to an example embodiment.

FIG. 11 shows a product overview with further extended telescopic shaft, according to an example embodiment.

FIG. 12 shows a close-up view of the retracted telescopic shaft with head configured to mount and rotate an electronic device, according to an example embodiment.

### DETAIL DESCRIPTION OF THE DISCLOSURE

In the following description, reference is made to the accompanying drawings which form a part hereof, and in which is shown by way of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to be taken in a limiting sense.

Example embodiments of the inventive concepts may be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, some dimensions are exaggerated for clarity.

It will be understood that when an element is referred to as being “connected” or “coupled” to another element, it can be directly connected or coupled to the other element or intervening elements may be present.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as coma only understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Before explaining at least one embodiment of the disclosure in detail, it is to be understood that the disclosure is not limited in its application to the details of construction and the arrangements of the components set forth in the following description. The disclosure is capable of other embodiments and of being practiced and carded out in various ways. Also, it is to be understood that the phraseology and terminology employed herein are fir the purpose of description and should not be regarded as limiting.

The present disclosure provides a stand for portable electronic devices equipped with camera permitting automatic and/or remote operation of the camera.

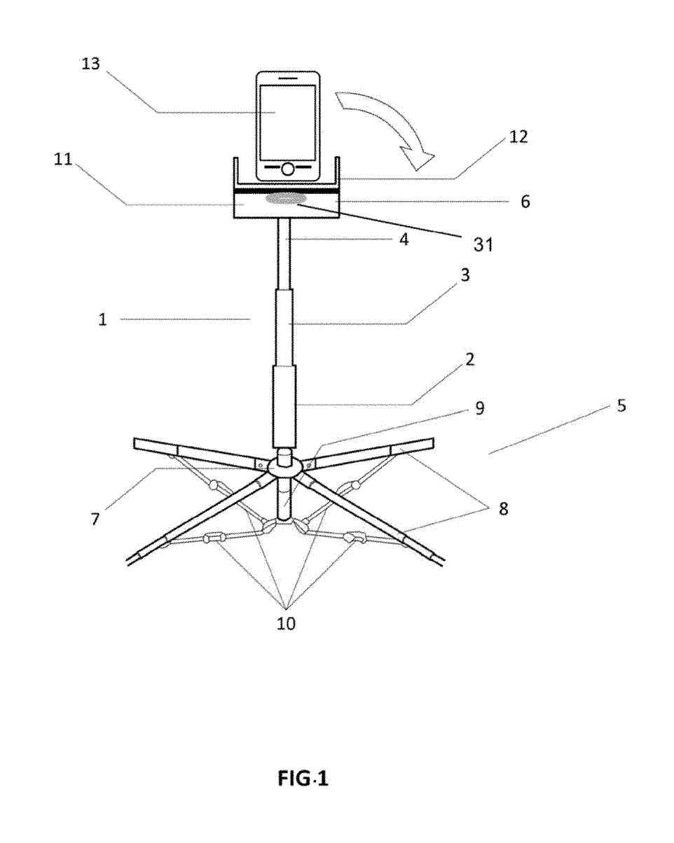

FIG. 1 shows a stand for electronic devices equipped with a camera. In an example embodiment, the stand includes a telescopic shaft 1 with bottom end and top end. The telescopic shaft includes an outer sheath 2 and two inner tubes 3 and 4. The shaft 1 is vertically supported on a base unit 5 and the top end of the shaft is coupled to the head unit 6. The base unit has a block 7 to which four legs are pivotally hinged. A stem 9 extends downwards from the block 7 and from the end of stem 9 are extended four leg braces 10 coupled to the four legs. The pivotally hinged legs 8 are supported by the leg braces 10 and are configured to fold and unfold up to desired angle. The head unit includes a housing 11 with a holder mounted on top 12. The holder 12 is configured to clamp the smart phone 13.

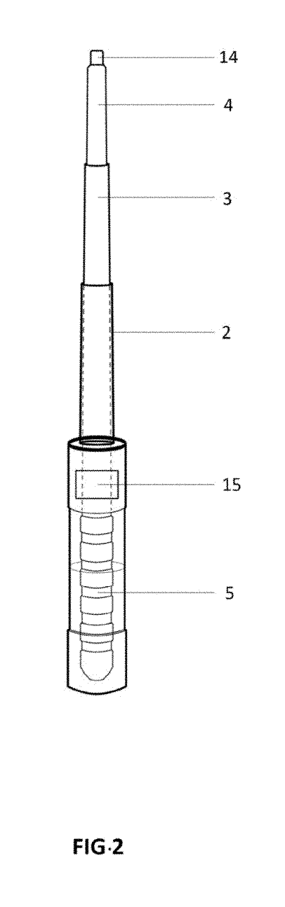

The FIG. 2 illustrate the telescopic shaft 1 having the outer sheath 2 with first inner tube 3 extending from the sheath 2 and second inner tube 4 extending from the first inner tube 3. The top end of the shaft includes a ball joint 14 for connecting the head unit 6. The base unit 5 is configured to fold. In an example embodiment, a push button 15 is provided for using the stand as a selfie stick wherein the button 15 is used to operate and control the camera.

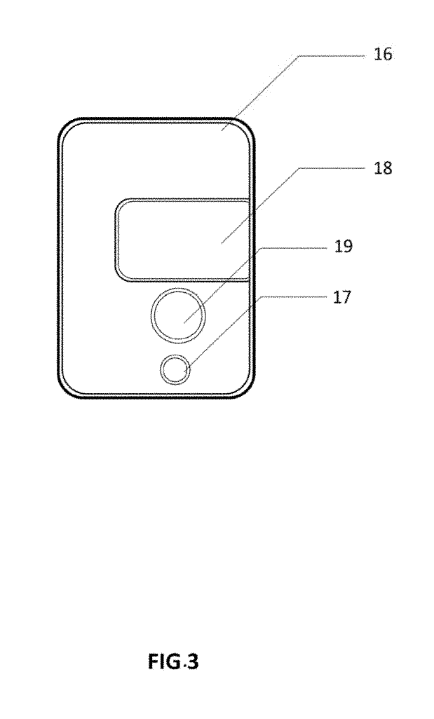

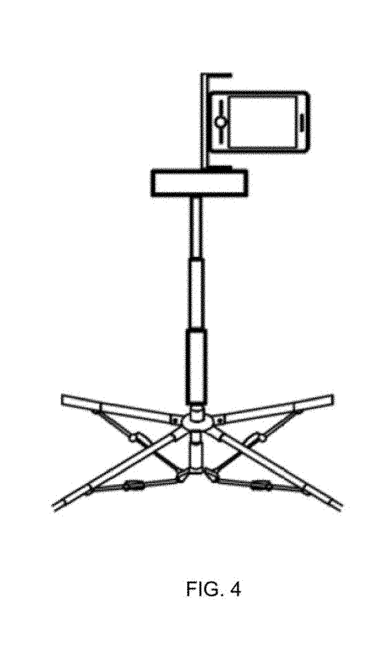

FIG. 3 illustrate a wearable remote device 16 used to operate the stand. The remote device 16 includes a transmitter 17 for sending signals to a sensor mounted in the housing 11, a start button 18 and stop button 19 for sending signal to the control unit for starting and stopping the control unit to operate the electronic device. The remote device 16 may have more buttons to control the operation of the electronic device as well as the operation of the motor to control the rotation of the holder holding the electronic device.

In an example embodiment, the telescopic shaft allows adjusting the height of the stand within a range. The telescopic shaft may be made of any suitable material such as metal and plastic, and preferably a light weight material such as plastic or aluminum. The base unit can hold the stand on a surface such as ground surface or a table top. The base unit may be similar to a tripod base that may be folded for storage and unfolded for use. In addition, the base unit may include more than three legs. For example, FIG. 1 shows four legs. Each leg has a leg foot made of any suitable grip material such as silicone or rubber, which provides stability to the stand and prevents minor shaking and sliding of the stand on the surface. The leg braces are configured to limit the pivoting movement of the legs at a predetermined angle allowing the stand to be supported on the ground or other surface. The leg braces may be made from flexible material allowing convenient folding of the legs. Alternatively, suitable hinge joints may be provided interrupting the leg braces permitting folding of the legs.

The top portion of the shall is coupled to the head unit and is the main part of the stand. The head unit may include a housing 11 enclosing the different components of the head unit 6. The top of the head unit may be coupled to a clamp or holder, which is adapted to mount different types of cameras and smart phones. The holder may be adapted to mount interchangeable clamps that may be removably attached to the holder. Different clamps may be provided fir attaching most kinds of camera and smart phones. The holder may allow the user to mount the electronic device in any suitable configuration for example, the user may mount the smart phone at desired angle such as 90 to capture portrait view. The housing may be coupled to the shaft through suitable mechanism for example using a ball joint. The housing encloses a plate coupled to the holder such that motor 31 enclosed in the housing and operably coupled to the rotating plate may rotate the rotating plate at desired speed, which in turn rotates the holder and thus the electronic device mounted on the holder. The motor may be a DC motor of sufficient capacity to rotate the rotating plate at desired speed. The motor may be powered by a battery that may also be enclosed in the housing. Furthermore, the battery may be rechargeable and suitable recharging apparatus may also be provided.

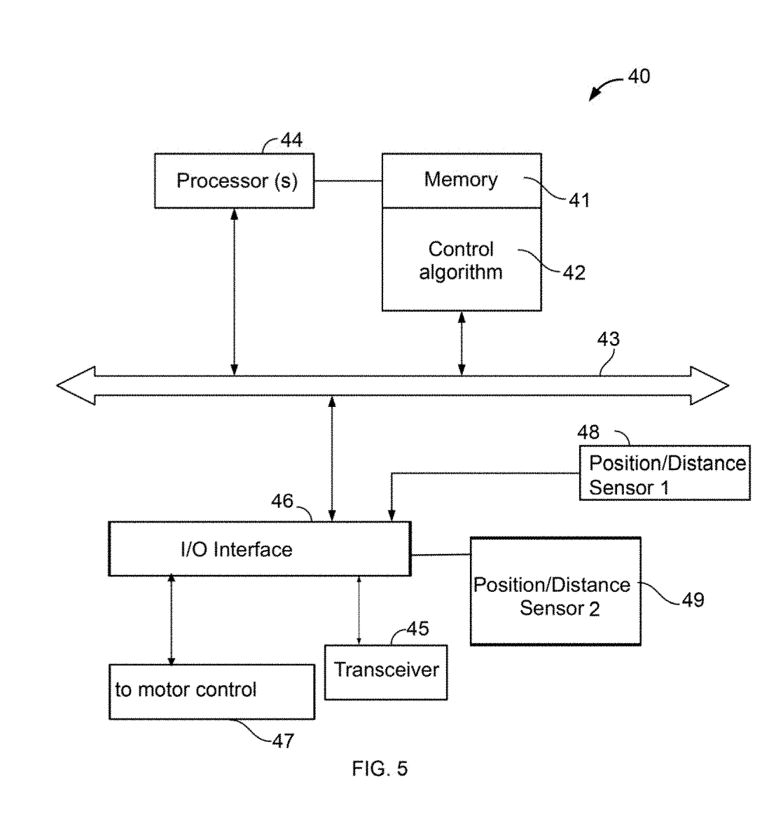

FIG. 5 illustrates the motor control interconnection for the rotation of the camera mounted on the head unit. To facilitate the operation of the motor, a controller 40 may be provided which controls the rotation of the rotating plate. The controller 40 includes one or more sensors 48, 49 for detecting the real-time position of the subject (for example, a user) based on the signals received from the remote device 16 and may track the movements of the subject. The controller 40 receives the real-time input from the one or more sensors 48, 49 and pans the camera to focus on the subject. The subject (for example, a user) is provided with a remote device that may be worn by the subject. For example, the remote device may include a clip for booking the device to the belt or any edge of the clothing. The remote device may include a transmitter that pray be tracked by the sensors 48, 49 coupled to the controller. In an example embodiment, the sensors 48, 49 may be IR sensors and the remote device may include the IR transmitter. The sensors 48, 49 may continuously receive the signals sent by the IR transmitter of the device 16 and send the sensed signal to an I/O interface 46 and to be stored in a memory 41. The memory 41 includes instructions algorithm for the microprocessor 44. The sensed signals received from the sensors 48 and 49 are processed by the microprocessor to track the real-time position of the subject wearing the remote device 16. The controller 40 operates the motor attached to pan by sending control signals to the motor control 47 based on the signals received from the sensors 48 and 49 so that the camera is continuously focused on the moving subject.

In an example embodiment, the microprocessor 44 receives instructions from the memory and sends the control signal to the motor control 47 to move and rotate the pan. The sensors 48, 49 may be equipped anywhere on the stand, preferably in the housing such that the sensors easily receive the signals from the transmitter. Moreover, equipping the sensor on the rotating plate or holder may ensure that the sensor always faces towards the transmitter i.e. if a user is moving around the stand, the control unit would rotate the electronic device according to the movement of the user so that the camera always focusses on the subject and thus the sensor would also remain facing the transmitter. Alternatively, two or more sensors may be mounted in the housing at opposite directions providing 360-degree field tracking. It is to be noted that any suitable sensors obvious to track the location of the subject may be used. For example, motion sensors, face sensors, acoustic sensors or proximity sensors may be used. The face sensor may be provided when the camera is required to keep a focus on particular subject, particularly when more than one people are present together.

In another example embodiment, two or more controllers are used to control the functions of the motor external to the portable electronic device (to rotate and move the portable electronic device), and to control the functions of camera motor inside the camera remotely.

In another example embodiment, the remote device may include controls for controlling the operation of the motor, for example the control unit may have a start button to signal the control device to start tracking the subject, and similarly stop button may also be provided. Suitable mechanism may be provided in the controller to manipulate certain functions of the electronic devices. Such functions include shutters to start capturing an image or video.

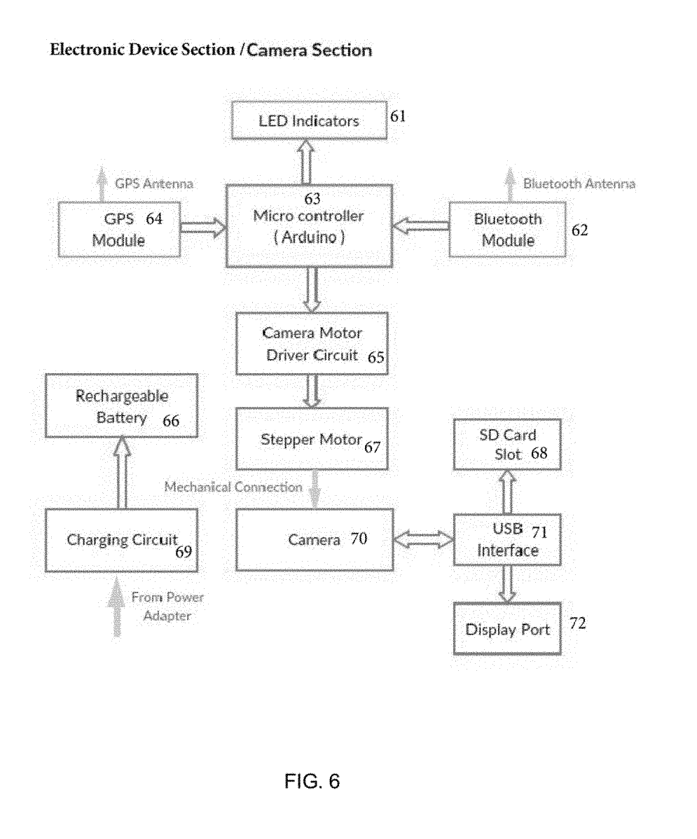

FIG. 6 shows communication among various parts and components with controller 63 associated with the cat era and camera motor and their interconnection. In an example embodiment, the position coordinate of the target GPS (associated with the subject) is received by the controller 63 via Bluetooth 62. The microcontroller 63 then compares the position coordinate of the target subject and with the previously obtained coordinates and sends the control commands for the camera motors driver circuit which in turn controls the stepper motor to control the camera 70 position and orientation.

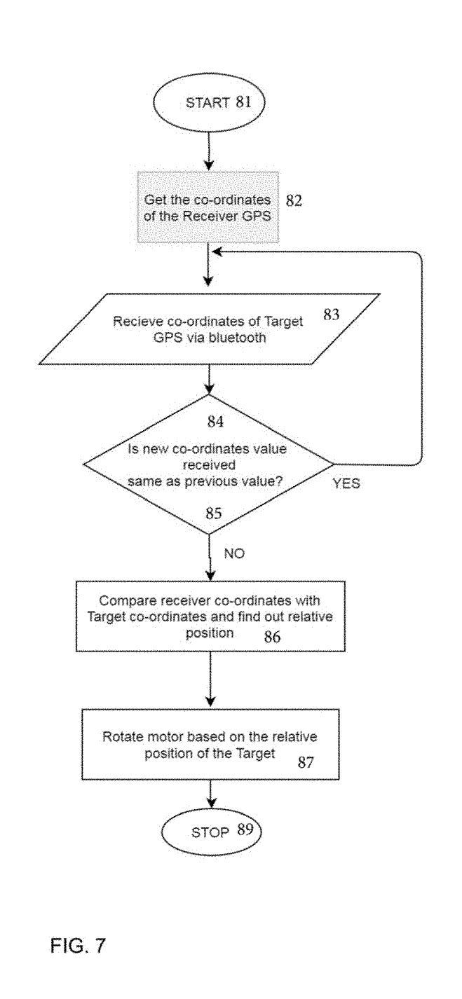

FIG. 7 describes the steps involved in data receiving and coordination between the camera and remote device 16.

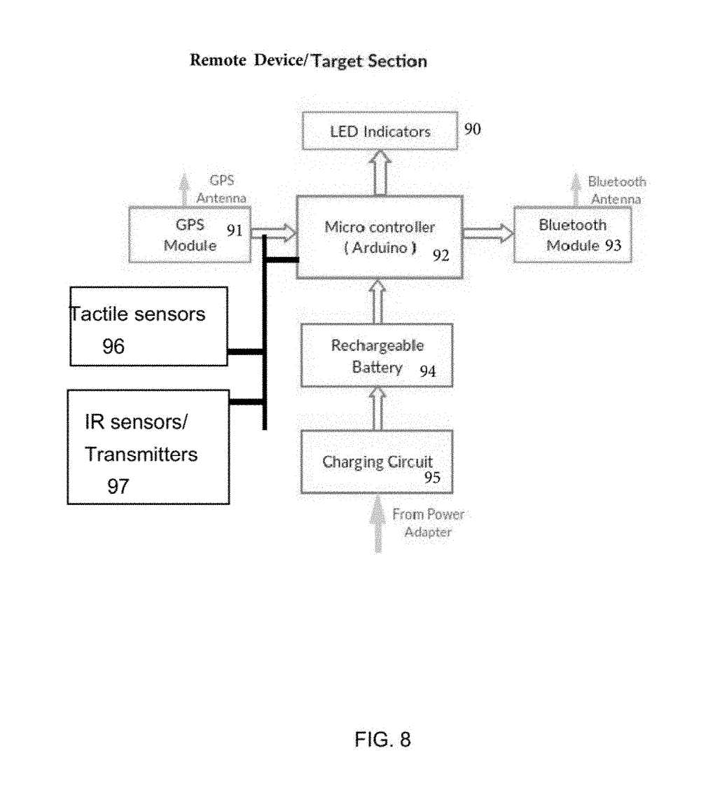

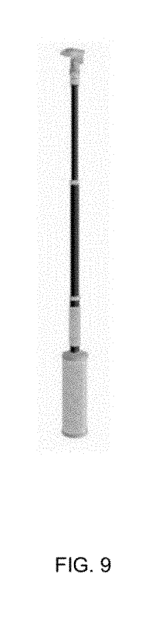

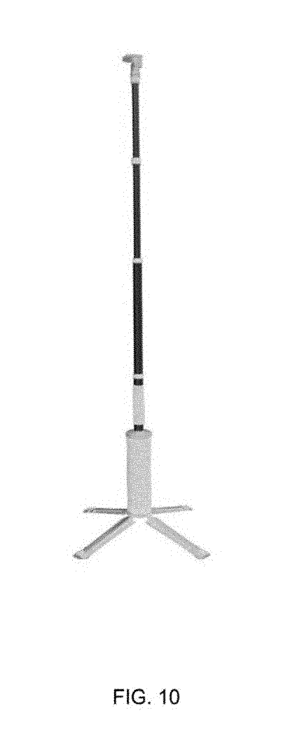

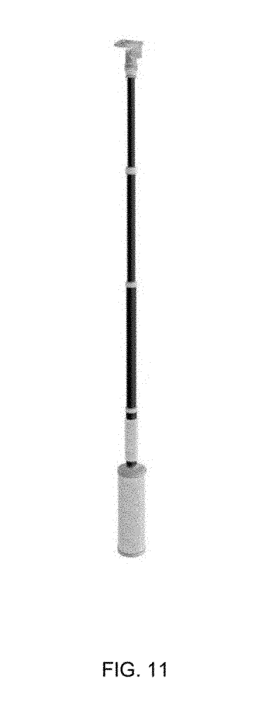

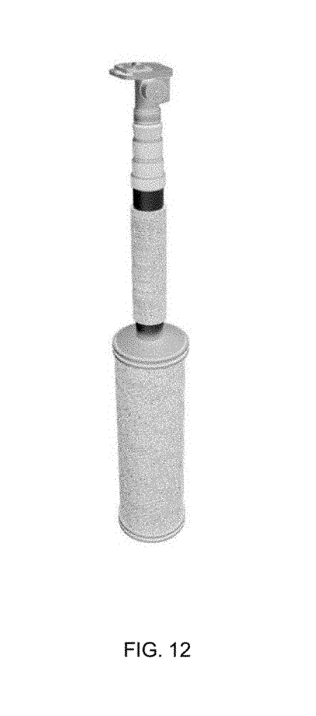

FIG. 8 shows interconnection in the wearable remote device 16 used to operate the stand and camera. Microcontroller receives the position information of the remote device and sends to the Bluetooth module 93. Bluetooth module 62 at the camera section receives the signal from the Bluetooth 93 and sends to the micro controller 63.

In another example embodiment, a IR sensor may be used in addition to the GPS module to further augment data and accuracy of the position of the subject being captured. Such IR sensors may be used in both camera section and target section (user area) covered by the remote wearable device 16. In an example embodiment, the remote wearable device may include two or more such IR transmitters.

In another example embodiment, control commands based on the user's operation are sent by Bluetooth module 93. The Bluetooth may also send position information based on the received signal from a GPS 91. Various tactile sensor 96 and IR sensors and transmitters 97 may be used in file remote device side (users side) to generate signals based on the user interaction and may be sent to the camera side sensors via Bluetooth or via IR transmitters.

In another example embodiment, the remote device 16 includes a transmitter 17 for sending signals to a sensor mounted in the housing 11, a start button 18 and stop button 19 for sending signal to the control unit for starting and stopping the control unit to operate the electronic device.

Furthermore, the stand may be used as a selfie stick permitting a person to capture their own images. The foldable stand may be collapsed to form the handle of the selfie stick, while the retractable shaft allows the head unit to be extended at desired length. Furthermore, the holder may be adapted such that the person holding the stand through the base unit in his/her hand while extending the stand away from him, the optical sensor of the camera or smartphone may face the person. Moreover, a push button may also be provided in the base unit such as the person holding the stand through the base unit may press the push button through his thumb for operating the camera often electronic device. The push button may be operably coupled to the control unit, such that pressing the button sends a signal to the control unit, and the control unit on receiving the signal causes the camera to capture the image.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present inventive concept have been described above with regard to specific embodiments. These benefits and advantages, and any elements or limitations that may cause them to occur or to become more pronounced are not to be construed as critical, required, or essential features of any or all of the embodiments.

While this specification contains many specific implementation details, these should not be construed as limitations on the scope of any inventive concept of what may be claimed, but rather as descriptions of features that may be specific to particular embodiments of particular inventive concept. Certain features that are described in this specification in the context of separate embodiments can also be implemented in combination in a single embodiment. Conversely, various features that are described in the context of a single embodiment can also be implemented in multiple embodiments separately or in any suitable sub combination.

What is claimed is:

1. A portable stand for a portable electronic device, comprising:
a telescopic shaft vertically supported on a base, the telescopic shaft being coupled to a housing at a top end, the base including a block coupled to the shaft and at least three legs pivotally coupled to the block wherein each leg is further supported by a leg brace permitting the base to unfold and fold;
a motor enclosed in the housing and operably coupled to a bolder through a coupling means, the holder being configured to clamp the portable electronic device, the motor being configured to rotate the holder;
a controller enclosed in the housing and operably coupled to the motor to control the operation of the motor;
at least one sensor operably coupled to the controller and configured to receive signal from a transmitter, the at least one sensor being configured to send a location signal to the controller to rotate the portable electronic device;
remote device configured to be worn by a user, the remote deice including the transmitter;
wherein the controller configured to receive the location signal from the at least one sensor in real time and continuously focus the sensor on the user.

1. The portable stand of claim 1, wherein the portable electronic device is a digital point and shoot camera.

2. The portable stand of claim 1, wherein the portable electronic device is a smart phone.

3. The portable stand of claim 1, wherein the base comprises four legs pivotally coupled to the block.

4. The portable stand of claim 1, wherein a push button is included at the base of the stand, the push button being operably coupled to the controller and configured such that when the base is folded to be gripped in a band of the user and a thumb lies against the push button.

5. The portable stand of claim 1, wherein the remote device further comprises a first start and stop button to control the controller.

6. The portable stand of claim 1, wherein the remote device includes a Bluetooth module configured to send the location data to a Bluetooth receiver associated with the portable electronic device.

7. The portable stand of claim 1, wherein the remote device includes one or more tactile sensors configured to send the control data to a receiver associated with the portable electronic device.

8. The portable stand of claim 1, wherein the remote device is configured to control functions of the camera by sending the control signals via Bluetooth.

9. The portable stand of claim 1, wherein the remote device is configured to control both position and orientation, and electronic function of the electronic device.

10. The portable stand of claim 1, wherein the position of the electronic device is automatically controlled based on the location signal received the at least one sensor.

11. The portable stand of claim 9, wherein the remote device further comprises a second start and stop button to control the controller of the electronic device to control the camera function of the electronic device.

12. The portable stand of claim 1, wherein the remote device further comprises a belt clip configured to hook the remote device to a belt worn by the user.

13. The portable stand of claim 1, wherein the sensor is an IR sensor and the transmitter is an IR transmitter.

14. The portable stand of claim 1, wherein the user is moving.

15. The portable stand of claim 1, wherein the stand further comprises a power supply to power the stand.

16. The portable stand of claim 12, wherein the power supply is one of a rechargeable battery, solar cells or a combination thereof.

17. The portable stand of claim 1, wherein the motor is a DC electric motor.
